(19) United States
(12) Patent Application Publication
(10) Pub. No.: US 2025/0316799 A1
(43) Pub. Date: Oct. 9, 2025

(54) BATTERY PACK

(71) Applicant: SAMSUNG SDI CO., LTD., Yongin-si (KR)

(72) Inventor: KYUNGSUK KO, Yongin-si (KR)

(21) Appl. No.: 19/085,014

(22) Filed: Mar. 20, 2025

(30) Foreign Application Priority Data
Apr. 5, 2024 (KR) 10-2024-0046952

(51) Int. Cl. H01M 50/124; H01M 50/126

(52) U.S. Cl. CPC H01M 50/1245; H01M 50/126

(57) ABSTRACT

A battery pack includes a battery cell including a first main surface and a second main surface facing each other, and cover tape including a first cover area and a second cover area being different areas on the first main surface and the second main surface of the battery cell, respectively, and an inner surface facing the battery cell and an outer surface facing away from the battery cell, wherein the cover tape includes a glossy coating layer forming an outer surface of the second cover area formed with a relatively small area.

### CROSS-REFERENCE TO RELATED APPLICATION

The present application claims priority and the benefit of Korean Patent Application No. 10-2024-0046952, filed on Apr. 5, 2024, in the Korean Intellectual Property Office, the disclosure of which is incorporated herein by reference in its entirety.

### BACKGROUND

### 1. Field

Embodiments relate to a battery pack.

### 2. Description of the Related Art

Typically, secondary batteries are batteries that allow charging and discharging, unlike primary batteries that do not allow charging. Secondary batteries are used as an energy source for mobile devices, electric vehicles, hybrid vehicles, electric bicycles, and uninterruptible power supplies may be used in the form of a single battery, depending on the type of external device to which they are applied or in the form of a pack in which multiple batteries are connected and bundled into one unit.

Small mobile devices, such as mobile phones, can operate for a certain period of time with the output and capacity of a single battery. If long-term operation or high-power operation is required, such as for larger mobile devices that consume more power, such as laptops or electric or hybrid vehicles, a pack containing multiple batteries is preferred due to issues with output and capacity. Depending on the number of built-in batteries, the output voltage or output current can be increased.

### SUMMARY

Embodiments include a battery pack, the battery pack including a battery cell including a first main surface and a second main surface facing each other, and cover tape including a first cover area and a second cover area being different areas on the first main surface and the second main surface of the battery cell, respectively, and an inner surface facing the battery cell and an outer surface facing away from the battery cell, wherein the cover tape includes a glossy coating layer forming an outer surface of the second cover area.

The outer surface of the second cover area may have a lower surface roughness than an outer surface of the first cover area.

The outer surface of the second cover area may have a higher reflectivity than an outer surface of the first cover area.

The outer surface of the second cover area may have a lower peel strength or adhesion than an outer surface of the first cover area.

With respect to peel strength or adhesion for peeling off counterpart objects attached to the outer surface of the second cover area and the outer surface of the first cover area from the outer surface of the second cover area and the outer surface of the first cover area, respectively, the peel strength or adhesion of the outer surface of the second cover area may be lower than a peel strength or adhesion of the outer surface of the first cover area.

The first cover area and the second cover area may be continuous along a tape base, the tape base being a common support base for the first cover area and the second cover area, an outer surface of the first cover area may be formed by an outer surface of the tape base, and the outer surface of the second cover area may be formed by the glossy coating layer on the outer surface of the tape base.

Compared to the outer surface of the tape base forming the outer surface of the first cover area, an outer surface of the glossy coating layer forming the outer surface of the second cover area may include at least one surface characteristic, the at least one surface characteristic including i) a lower surface roughness, ii) a higher reflectivity, or iii) a lower peel strength or adhesion.

Compared to the outer surface of the tape base of the second cover area where the glossy coating layer is formed, the outer surface of the second cover area formed by the glossy coating layer may include at least one surface characteristic, the at least one surface characteristic including i) a lower surface roughness, ii) a higher reflectivity, or iii) a lower peel strength or adhesion.

The cover tape may include the tape base forming a common support base for the first and second cover areas, the glossy coating layer formed in the second cover area on the outer surface of the tape base, and an adhesive layer formed in the first and second cover areas on an inner surface of the tape base.

The battery cell may further includes a top surface and a bottom surface opposite each other that connect the first main surface to the second main surface, and a first side surface and a second side surface opposite each other in a direction intersecting a direction in which the top surface faces the bottom surface, and connect the first and second main surfaces to each other, wherein the first main surface and the second main surface occupy a greater area than any of the top surface, the bottom surface, the first side surface and the second side surface.

The second cover area may include a second-1 cover area extending from the first cover area formed on the first main surface to the second main surface and surrounding the first side surface, a second-2 cover area extending from the first cover area formed on the first main surface to the second main surface and surrounding the second side surface, and a second-3 cover area extending from the first cover area formed on the first main surface to the second main surface and surrounding the bottom surface.

The second-1 cover area may be formed on the second main surface at a location adjacent to the first side surface, the second-2 cover area may be formed on the second main surface at a location adjacent to the second side surface, and the second-3 cover area may be formed on the second main surface at a location adjacent to the bottom surface, wherein an inner area of the second main surface including a central area of the second main surface is exposed from the second cover area.

Protective tape may be attached to the inner area of the second main surface exposed from the second cover area.

The protective tape may cover the inner area of the second main surface exposed from the cover tape and may cover end portions of the second-1 cover area, the second-2 cover area, and the second-3 cover area, which extend toward the inner area.

A peeling tab for peeling off the protective tape may be formed on the protective tape.

The second-1 cover area, the second-2 cover area, and the second-3 cover area may be different areas and different shapes from each other.

The second-1 cover area may include a wide width portion and a narrow width portion which are stepped at different widths in a longitudinal direction of the first side surface, the second-2 cover area may extend with a uniform width in a longitudinal direction of the second side surface, and the second-3 cover area may include a pair of second-3 cover areas spaced apart from each other in a longitudinal direction of the bottom surface.

The wide width portion of the second-1 cover area may be arranged at a location relatively close to the first side surface with a relatively wide width in a longitudinal direction of the first side surface, and the narrow width portion of the second-2 cover area may be arranged at a location relatively far from the first side surface with a relatively narrow width in the longitudinal direction of the first side surface.

Among the second-1 cover area, the second-2 cover area, and the second-3 cover area, the second-1 cover area is formed with a largest area, the second-3 cover area is formed with a smallest area, and the second-2 cover area is formed with a smaller area than the second-1 cover area and a larger area than the second-3 cover area.

The cover tape may include an area connected to the second-1 cover area and the second-2 cover area and covering the first and second side surfaces adjacent to the second main surface of the battery cell, and an area connected to the area covering the first and second side surfaces and covering the top surface and the bottom surface adjacent to the first and second side surfaces.

### BRIEF DESCRIPTION OF THE DRAWINGS

Features will become apparent to those of ordinary skill in the art by describing in detail exemplary embodiments with reference to the attached drawings, in which:

FIG. 1 is a perspective view of a first main surface of a battery pack according to one or more embodiments;

FIG. 2 is a perspective view of a second main surface of the battery pack shown in FIG. 1 according to one or more embodiments;

FIG. 3 is a perspective view of a first main surface of a battery cell as a component of the battery pack shown in FIG. 1 according to one or more embodiments;

FIG. 4 is an exploded perspective view of a second main surface of the battery pack shown in FIG. 1 according to one or more embodiments;

FIG. 5 is a plan view of a second main surface of the battery pack shown in FIG. 1 according to one or more embodiments;

FIG. 6 is an expanded view of the cover tape shown in FIG. 1 according to one or more embodiments;

FIG. 7 is a cross-sectional view of the cover tape taken along line VII-VII in FIG. 6 according to one or more embodiments;

FIGS. 8A and 8B are diagrams illustrating different reflection characteristics of a second cover area and a first cover area for incident light to explain the different reflectivity as a surface characteristic of the first cover area and the second cover area of the cover tape shown in FIG. 1 according to one or more embodiments;

FIGS. 9A and 9B are diagrams illustrating the peel strength or adhesion of a second cover area and a first cover area, respectively, against peeling of protective tape and set tape from the second cover area and the first cover area to explain the different peel strength or adhesion as a surface characteristic of the first cover area and the second cover area of the cover tape shown in FIG. 1 according to one or more embodiments; and

FIGS. 10A and 10B show the results of an experiment for evaluating the adhesion of a cover tape without a glossy coating layer and the adhesion of a cover tape with a glossy coating layer to confirm the difference in adhesion depending on whether or not a glossy coating layer is formed according to one or more embodiments.

### DETAILED DESCRIPTION

Example embodiments will now be described more fully hereinafter with reference to the accompanying drawings; however, they may be embodied in different forms and should not be construed as limited to the embodiments set forth herein. Rather, these embodiments are provided so that this disclosure will be thorough and complete, and will fully convey exemplary implementations to those skilled in the art.

In the drawing figures, the dimensions of layers and regions may be exaggerated for clarity of illustration. It will also be understood that if a layer or element is referred to as being “on” another layer or substrate, it can be directly on the other layer or substrate, or intervening layers may also be present. Further, it will be understood that if a layer is referred to as being “under” another layer, it can be directly under, and one or more intervening layers may also be present. In addition, it will also be understood that if a layer is referred to as being “between” two layers, it can be the only layer between the two layers, or one or more intervening layers may also be present. Like reference numerals refer to like elements throughout.

As used herein, the term “and/or” includes any and all combinations of one or more of the associated listed items. Expressions such as “at least one of,” if preceding a list of elements, modify the entire list of elements and do not modify the individual elements of the list.

Hereinafter, a battery pack according to one or more embodiments is described with reference to the drawings.

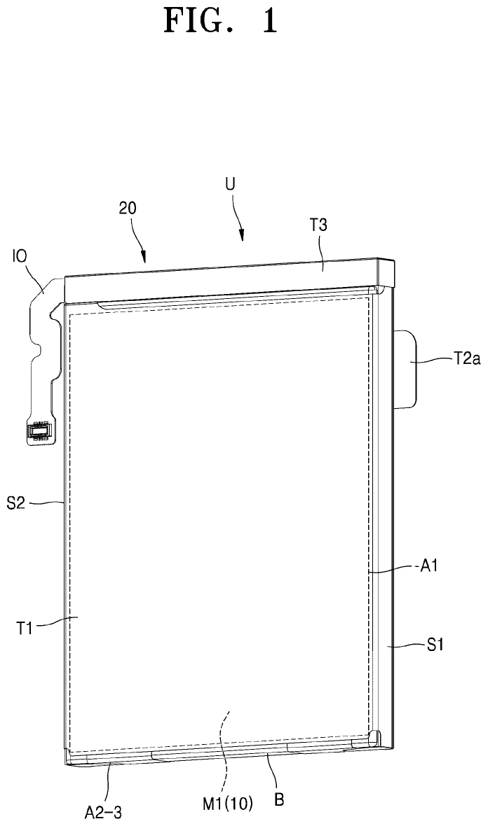

FIG. 1 is a perspective view of a first main surface of a battery pack according to one or more embodiments.

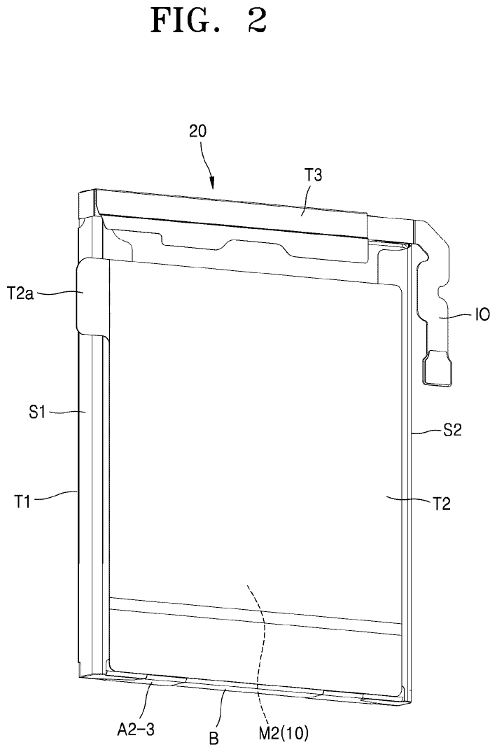

FIG. 2 is a perspective view of a second main surface of the battery pack shown in FIG. 1 according to one or more embodiments.

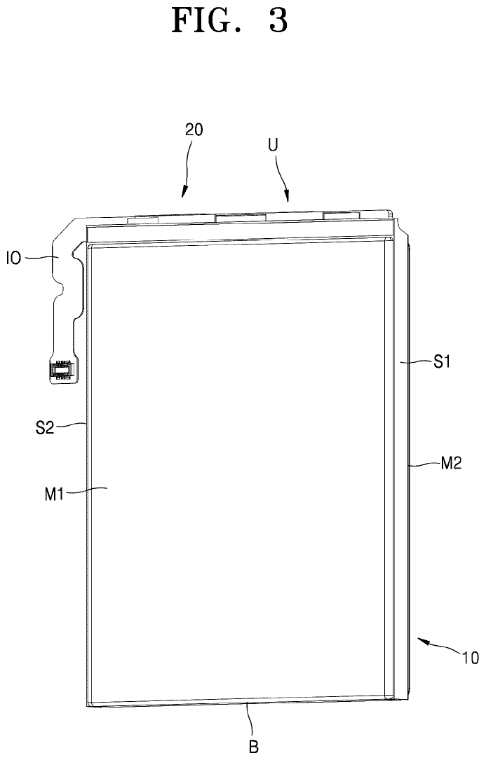

FIG. 3 is a perspective view of a first main surface of a battery cell as a component of the battery pack shown in FIG. 1 according to one or more embodiments.

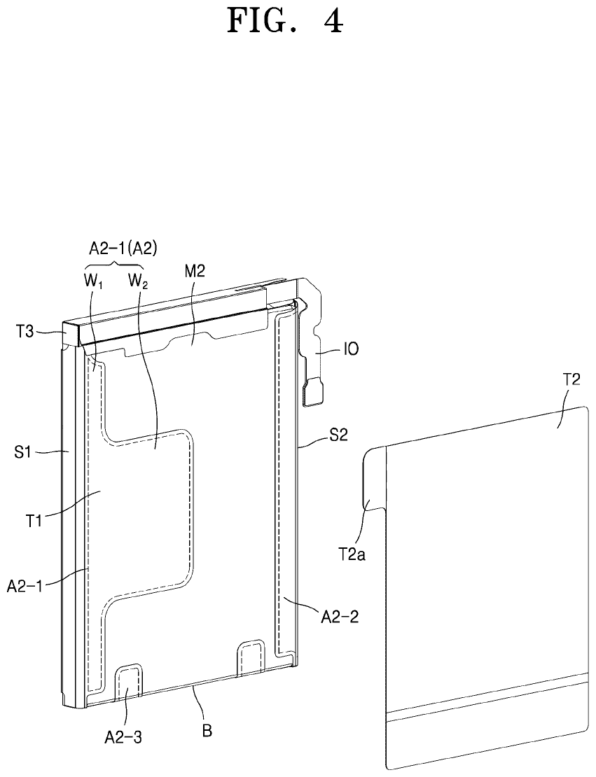

FIG. 4 is an exploded perspective view of a second main surface of the battery pack shown in FIG. 1 according to one or more embodiments.

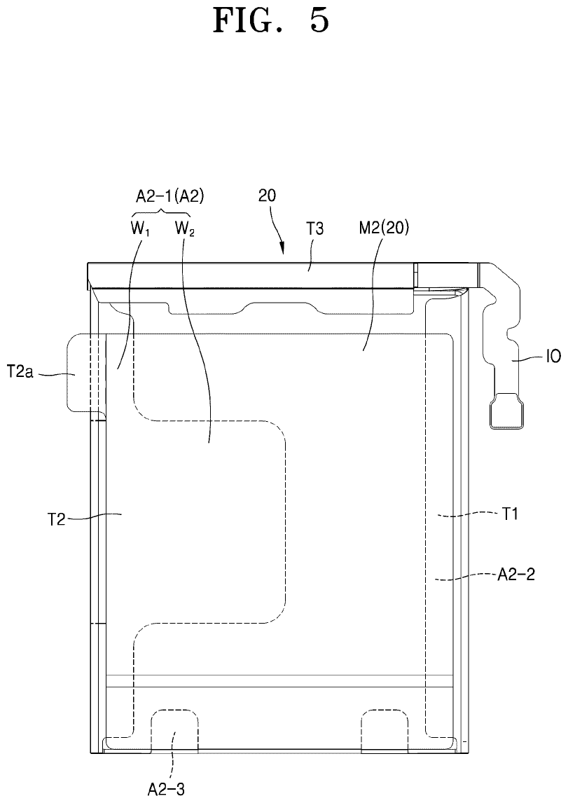

FIG. 5 is a plan view of a second main surface of the battery pack shown in FIG. 1 according to one or more embodiments.

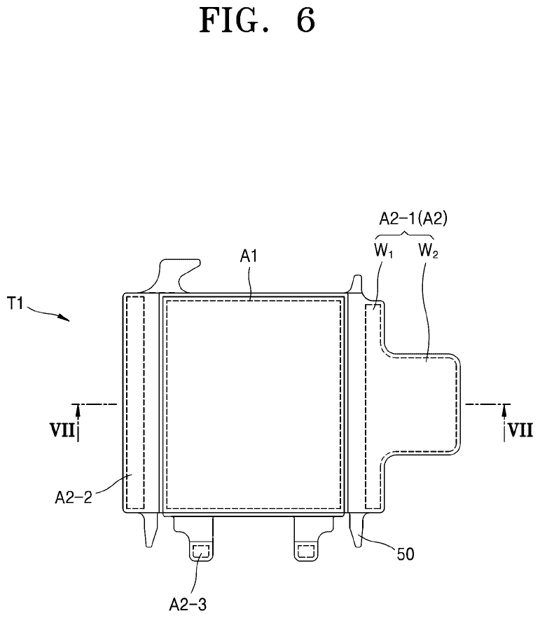

FIG. 6 is an expanded view of the cover tape shown in FIG. 1 according to one or more embodiments.

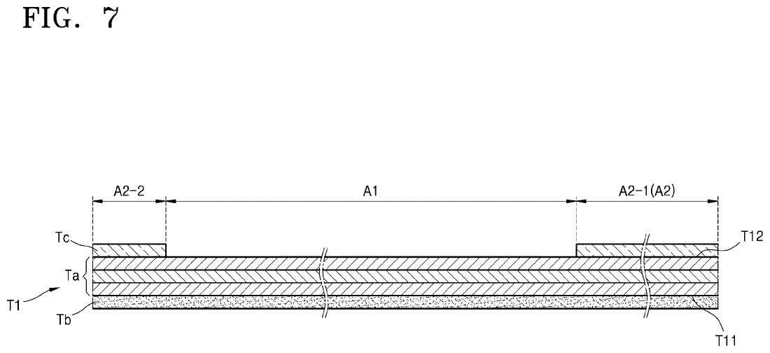

FIG. 7 is a cross-sectional view of the cover tape taken along line VII-VII in FIG. 6 according to one or more embodiments.

Referring to the drawings, the battery pack according to one or more embodiments may include a battery cell 10 including a first main surface M1 and a second main surface M2 which face each other, and cover tape attached to the first and second main surfaces M1 and M2 of the battery cell 10.

According to one or more embodiments, the battery cell 10 may include the first main surface M1 and the second main surface M2 which occupy a relatively large area and face each other as a pair, a top surface U and a bottom surface B which connect the first main surface M1 to the second main surface M2 and face each other as a pair, and a first side surface S1 and a second side surface S2 which connect the first main surface M1 to the second main surface M2 and face each other in a direction intersecting a direction in which the top surface U faces the bottom surface B.

According to one or more embodiments, the top surface U of the battery cell 10 may be formed as an electrode surface on which the electrodes of the battery cell 10 are arranged and charging power and discharging power may be input and output as electrical input and output of the battery cell 10 through the top surface U or the electrode surface. To this end, a circuit portion 20 electrically connected to the electrodes of the battery cell 10 may be disposed on the top surface U or the electrode surface of the battery cell 10. According to one or more embodiments, the circuit portion 20 may include a circuit board equipped with a switch device, such as a field effect transistor (FET), to control the charging and discharging operation of the battery cell 10 and input/output wiring IO connected to the circuit board, forming a path for charging and discharging current of the battery cell 10, and connected to an external device (external charger or external load).

According to one or more embodiments, the battery cell 10 may be surrounded by the cover tape T1. For example, the cover tape T1 may extend toward the second main surface M2 while covering the first main surface M1 of the battery cell 10. To cover substantially the entire first main surface M1 of the battery cell 10 and a part of the second main surface M2 of the battery cell 10, a part of the cover tape T1 may cover the entire first main surface M1 and the remaining part of the cover tape T1 may extend toward the second main surface M2 opposite to the first main surface M1 to cover a part of the second main surface M2. According to one or more embodiments, the cover tape T1 may cover the first and second main surfaces M1 and M2 with different first and second cover areas A1 and A2. The first cover area A1 where the cover tape T1 covers the first main surface M1 of the battery cell 10 may correspond to substantially the entire area of the first main surface M1 and the second cover area A2 where the cover tape T1 covers the second main surface M2 of the battery cell 10 may correspond to a partial area smaller than the entire area of the second main surface M2. However, according to some embodiments, to the extent that the cover tape T1 covers the first and second main surfaces M1 and M2 of the battery cell 10 with the different first and second cover areas A1 and A2, the cover tape T1 may cover all or a part of the first main surface M1 of the battery cell 10 and may cover a part of the second main surface M2 of the battery cell 10. In other words, the cover tape T1 may cover all or a part of the first main surface M1 of the battery cell 10 and may cover a part of the second main surface M2 of the battery cell 10 which is smaller than the first cover area A1 covering the first main surface M1 of the battery cell 10. However, the cover tape T1 does not cover the entire second main surface M2 of the battery cell 10.

Referring to FIGS. 1 to 5, according to one or more embodiments, insulating tape T3 may surround the circuit portion 20 arranged on the top surface U of the battery cell 10. The insulating tape T3 may protect the circuit portion 20 from physical and electrical interferences between the circuit portion 20 and the surroundings by surrounding at least a part of the circuit portion 20 arranged on the top surface U of the battery cell 10.

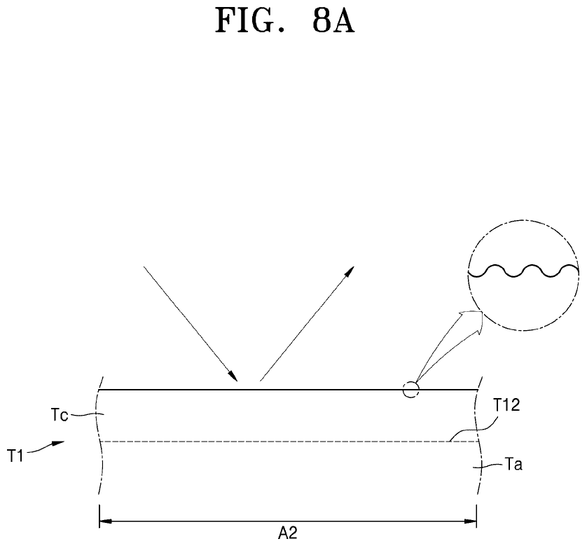

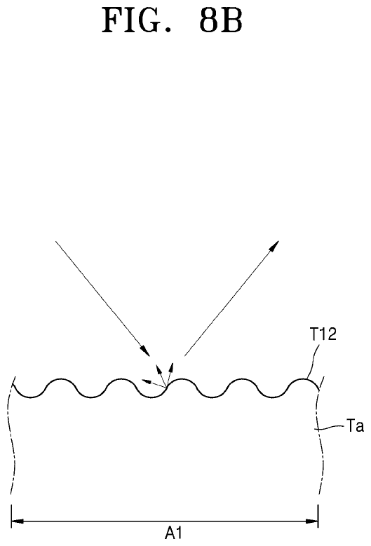

FIGS. 8A and 8B are diagrams illustrating different reflection characteristics of a second cover area and a first cover area for incident light to explain the different reflectivity as a surface characteristic of the first cover area and the second cover area of the cover tape shown in FIG. 1.

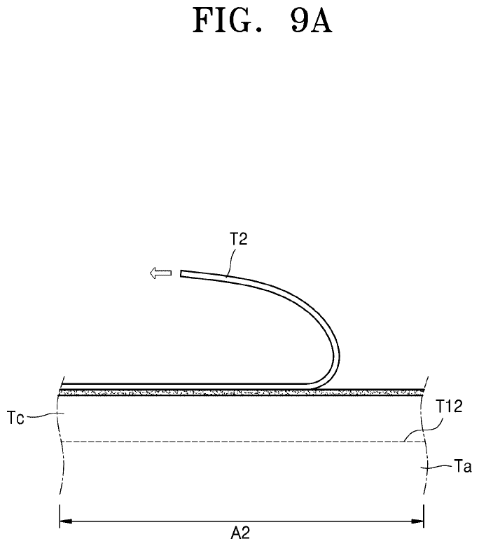

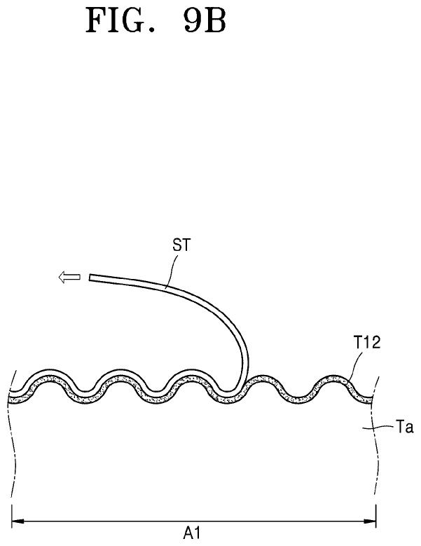

FIGS. 9A and 9B are diagrams illustrating the peel strength or adhesion of the second cover area and the first cover area, respectively, against peeling of protective tape and set tape from the second cover area and the first cover area to explain the different peel strength or adhesion as a surface characteristic of the first cover area and the second cover area of the cover tape shown in FIG. 1.

Referring to the drawings, according to one or more embodiments, the cover tape T1 may be formed in different configurations in the first and second cover areas A1 and A2 to exhibit different surface characteristics. For example, according to some embodiments, the cover tape T1 may have different surface characteristics, such as different reflectivity, surface roughness, or peel strength (or adhesion). According to one or more embodiments, the fact that the cover tape T1 has different surface characteristics in the first and second cover areas A1 and A2 may mean that differences in surface characteristics on the surfaces of the first and second cover areas A1 and A2 are shown through different surface treatments or by forming the surfaces of the first and second cover areas A1 and A2 of the cover tape T1 in different configurations. For example, according to some embodiments, the reflectivity, which refers to a relative ratio of the intensity of reflected light to the intensity of incident light incident on the surface of the cover tape T1, may correspond to a surface characteristic of the cover tape T1. The surface roughness, which is a measure of whether the surface of the cover tape T1 forms a rough surface or a smooth surface, may correspond to a surface characteristic of the cover tape T1. The peel strength (or adhesion) which refers to a strength for peeling a counterpart object attached to the cover tape T1 with the same adhesive from the cover tape T1 may also correspond to a surface characteristic of the cover tape T1. That is, the peel strength (or adhesion) of the cover tape T1 or the peel strength (or adhesion) of the first and second cover areas A1 and A2 forming the cover tape T1, as a surface characteristic of the cover tape T1 or the first and second cover areas A1 and A2, may refer to a strength for peeling the counterpart object attached to the cover tape T1 or the first and second cover areas A1 and A2 from the cover tape T1, rather than a strength to peel off the cover tape T1 or the first and second cover areas A1 and A2. For example, according to one or more embodiments, the peel strength or adhesion may refer to a strength required to peel the protective tape T2 attached to the second cover area A2 or the cover tape T1 forming the second cover area A2 from the second cover area A2 or the cover tape T1 forming the second cover area A2.

As such, according to one or more embodiments, the first cover area A1 of the cover tape T1 disposed on the first main surface M1 of the battery cell 10 may have different surface characteristics from the second cover area A2 of the cover tape T1 disposed on the second main surface M2 of the battery cell 10. For example, the first and second cover areas A1 and A2 of the cover tape T1 may have the following relationship with respect to the surface characteristics listed above:
i) reflectivity of the first cover area A1<reflectivity of the second cover area A2,
ii) surface roughness of the first cover area A1>surface roughness of the second cover area A2, and
iii) peel strength of the first cover area A1>peel strength of the second cover area A2.

According to one or more embodiments, the first cover area A1 may be formed with a relatively rough surface and the second cover area A2 may be formed with a relatively smooth surface. Accordingly, the second cover area A2 formed with a relatively smooth surface may have a relatively higher reflectivity, a relatively lower surface roughness, and a relatively lower peel strength than the first cover area A1 formed with a relatively rough surface. For example, according to one or more embodiments, the second cover area A2 formed with a relatively smooth surface may provide a relatively lower adhesive area than the first cover area A1 formed with a relatively rough surface and may have the limited volume of pores that can accommodate the adhesive due to the relatively small volume of pores.

The second cover area A2 formed with a relatively smooth surface may provide a relatively small adhesive area between the counterpart object and the second cover area A2. In other words, the first cover area A1 formed with a relatively rough surface may increase the adhesive area through a plurality of uneven shapes formed on the surface thereof and provide pores of sufficient volume to accommodate the adhesive due to the uneven shapes. Accordingly, the first cover area A1 may provide a higher peel strength than the second cover area A2 formed with a smooth surface.

According to one or more embodiments, the cover tape T1 does not include an additional configuration to protect the first main surface M1 exposed from the first cover area A1, while substantially covering the entire first main surface M1 in the relatively larger first cover area A1. Unlike the first cover area A1, the second cover area A2, which covers the second main surface M2 of the battery cell 10, may be formed as the remaining part of the cover tape T1 extends toward the second main surface M2 of the battery cell 10 after the part of the cover tape T1 covers the first main surface M1 of the battery cell 10. According to one or more embodiments, the second main surface M2, which is partially covered by the remaining part of the cover tape T1 after the part of the cover tape T1 covers the first main surface M1, unlike the first main surface M1 which is substantially entirely covered by the first cover area A1 of the cover tape T1, a part of the second main surface M2 may be covered by the second cover area A2 of the cover tape T1 and the other part thereof which is not covered by the second area A2 of the cover tape T1 may be exposed from the cover tape T1. According to one or more embodiments, in that the first cover area A1 covering the first main surface M1 of the battery cell 10 and the second cover area A2 covering the second main surface M2 of the battery cell 10 may have different areas, while the first and second main surfaces M1 and M2 of the battery cell 10 may have substantially the same area, the second cover area A2 formed in a relatively small area may expose a part of the second main surface M2, rather than covering the entire second main surface M2. As such, the protective tape T2, separate from the cover tape T1, may be attached to the second main surface M2 to cover the exposed part of the second main surface M2 of the battery cell 10 without being covered by the cover tape T1. The protective tape T2 may cover a part of the second main surface M2 of the battery cell 10 exposed from the cover tape T1 as well as the second cover area A2 of the cover tape T1. As such, the protective tape T2 may overlap with the cover tape T1 on the second main surface M2 of the battery cell 10 without forming a space between the protective tape T2 and the cover tape T1. For example, the second main surface M2 of the battery cell 10 exposed from the space between the protective tape T2 and the cover tape T1 may not be exposed, thereby blocking the formation of physical and electrical interference with the surroundings surrounding the battery cell 10. In addition, unlike the first cover area A1 of the cover tape T1, which covers all or most of the first main surface M1, the second cover area A2, which covers only a part of the second main surface M2, may be lifted due to the lack of adhesion to the battery cell 10. For example, an end portion where the cover tape T1 terminates may be formed in the second cover area A2 formed by the remaining part of the cover tape T1 after the part of the cover tape T1 covers the first main surface M1 of the battery cell 10. Accordingly, the end portion of the second cover area A2, which has relatively poor adhesion to the battery cell 10, may be peeled from the battery cell 10 or may cause adhesion defects, such as lifting from the battery cell 10. The protective tape P2 may eliminate failure or lack of adhesion of the second cover area A2 by covering a part of the second main surface M2 of the battery cell 10 exposed from the second cover area A2 together with the end portion of the second cover area A2. The end portion of the second cover area A2 may be protected inside the protective tape T2 without being exposed by the protective tape T2 covering the end portion of the second cover area A2.

The protective tape T2 may cover a part of the second main surface M2 of the battery cell 10 exposed from the second cover area A2, e.g., a central area of the second main surface M2 of the battery cell 10 exposed from the second cover area A2. For example, according to one or more embodiments, the protective tape T2 may cover the end portion of the second cover area A2 together with the central area of the second main surface M2 which can be exposed from the second cover area A2 of the cover tape T1 formed by the remaining part of the cover tape T1 after the part of the cover tape T1 covers the first main surface M1.

According to one or more embodiments, the second main surface M2 of the battery cell 10 may include a second-1 cover area A2-1 and a second-2 cover area A2-2 which extend from the first main surface M1 to the second main surface M2 and surround the first side surface S1 and the second side surface S2, respectively. For example, according to one or more embodiments, the second main surface M2 of the battery cell 10 may include the second-1 cover area A2-1 which extends from the first main surface M1 to the second main surface M2 and surrounds the first side surface S1, the second-2 cover area A2-2 which extends from the first main surface M1 to the second main surface M2 and surrounds the second side surface S2, and a second-3 cover area A2-3 which extends from the first main surface M1 to the second main surface M2 and surrounds the bottom surface B. As such, the second cover area A2 may include the second-1 cover area A2-1, the second-2 cover area A2-2, and the second-3 cover area A2-3 which are formed by the remaining part of the cover tape T1 after the part of the cover tape T1 covers the first main surface M1 and may have different placement relationships on the second main surface M2. For example, the second-1 cover area A2-1 may be formed mainly at a location adjacent to the first side surface S1 of the battery cell 10, the second-2 cover area A2-2 may be formed mainly at a location adjacent to the second side surface S2 of the battery cell 10, and the second-3 cover area A2-3 may be formed mainly at a location adjacent to the bottom surface B of the battery cell 10. In addition, the second-1 cover area A2-1, the second-2 cover area A2-2, and the second-3 cover area A2-3 forming the second cover area A2 may have different areas, and, for example, may have the following relationship with respect to the areas: area of the second-1 cover area A2-1 >area of the second-2 cover area A2-2 >area of the second-3 cover area A2-3.

According to one or more embodiments, the second-1 cover area A2-1 extending from the first main surface M1 to the second main surface M2 and surrounding the first side surface S1 may be formed in a stepped shape in the longitudinal direction of the first side surface S1. For example, according to one or more embodiments, the second-1 cover area A2-1 may include a wide width portion W1 which is formed with a relatively wide width and a narrow width portion W2 which is formed with a relatively narrow width in the longitudinal direction of the first side surface S1. With respect to the stepped arrangement of the wide width portion W1 and the narrow width portion W2 in the longitudinal direction of the first side surface S1, the wide width portion W1 may be formed relatively adjacent to the first side surface S1 and the narrow width portion W2 may be formed relatively far from the first side surface S1.

According to one or more embodiments, the protective tape T2 may be placed on the cover tape T1. The protective tape T2 attached to the cover tape T1 may cause inconvenience in maintenance of the battery cell 10 due to the adhesive of the protective tape T2 remaining on the cover tape T1 if peeled from the protective tape T2. The cover tape T1 contaminated with the adhesive of the protective tape T2 may cause failure if peeled from the battery cell 10 for maintenance of the battery cell 10. For example, according to one or more embodiments, the protective tape T2 may be attached together on the second main surface M2 and the cover tape T1 attached to the second main surface M2. By covering the second main surface M2 and the cover tape T1 attached to the second main surface M2, the protective tape T2 may block the peeling of the cover tape T1 initiated from the end portions of the second main surface M2 exposed from the cover tape T1 and the cover tape T1 attached to the second main surface M2. According to one or more embodiments, to provide a peeling start position of the protective tape T2 from the second main surface M2 and the cover tape T1 on the second main surface M2, the protective tape T2 may include a peeling tab T2a which protrudes from the main body of the cover tape T1. For example, according to one or more embodiments, the peeling tab T2a of the protective tape T2 may protrude from the protective tape T2 attached to the second main surface M2 to a position outside the second main surface M2 of the battery cell 10.

According to one or more embodiments, to eliminate the contamination of the cover tape T1 due to the adhesive of the protective tape T2 if the protective tape T2 is peeled from the cover tape T1, the surface characteristics of the second cover area A2 disposed on the second main surface M2 of the battery cell 10 may be improved, wherein the cover tape T1 and the protective tape T1 have a stepped structure to overlap with each other on the second main surface M2 of the battery cell 10. For example, the surface characteristics of the second cover area A2 may be improved so that the second cover area A2 has different surface characteristics from the first cover area A1 disposed on the first main surface M1 of the battery cell 10. According to one or more embodiments, the second cover area A2 may have a relatively lower surface roughness, a higher reflectivity, or a lower peel strength (adhesion) than the first cover area A1. According to one or more embodiments, a coating layer Tc may be formed on the surface of the second cover area A2 of the cover tape T1. According to one or more embodiments, a glossy coating layer Tc may be formed on the surface of the second cover area A2. For example, the surface of the first cover area A1 of the cover tape T1 may be formed as a relatively rough surface and the surface of the second cover area A2 thereof may be formed as a relatively smoother surface than the first cover area A1. For example, set tape ST (see FIG. 9B) for preventing a component from falling out of a set device equipped with a battery pack according to one or more embodiments and using the battery pack as a driving power source or for blocking physical or electrical interference from other components of the set device may be attached to the first cover area A1 covering the first main surface M1 of the battery cell 10. According to one or more embodiments, the set tape ST (see FIG. 9B) may be attached to the first cover area A1 covering the first main surface M1 of the battery cell 10. The first cover area A1 covering the first main surface M1 of the battery cell 10 may be formed with a relatively rough surface in consideration of the adhesion with the set tape ST (see FIG. 9B). For example, the relatively rough surface of the first cover area A1 may increase the adhesive area to the set tape ST (see FIG. 9B) and the volume of pores that can accommodate the adhesive, thereby increasing the adhesion with the set tape ST (see FIG. 9B).

For example, according to one or more embodiments, the fact that the first and second cover areas A1 and A2 of the cover tape T1 have different surface characteristics may mean different situations in which different surface properties are observed. For example, the fact that the first and second cover areas A1 and A2 have a rough surface that is relatively advantageous for adhesion and a smooth surface that is relatively advantageous for peeling, respectively, may mean that the first cover area A1 having the relatively rough surface has a relatively higher surface roughness than the second cover area A2 having the relatively smooth surface if observing the physical structure of the first and second cover areas A1 and A2. For example, the reflectivity of the first and second cover areas A1 and A2 is a ratio of the intensity of reflected light reflected from the first and second cover areas A1 and A2 to the intensity of incident light incident on the first and second cover areas A1 and A2, respectively, from an optical perspective. The high reflectivity, close to specular reflection, due to a relatively low surface roughness may be measured in the second cover area A2 which has a relatively smooth surface, while the relatively low reflectivity, such as scattering or diffuse reflection, due to a high surface roughness is measured in the first cover area A1 which has a relatively rough surface. In addition, with respect to the peel strength (adhesion), i.e., the peel strength (adhesion) for peeling off the counterpart object attached via an adhesive to the first and second cover areas A1 and A2 from the first and second cover areas A1 and A2, the second cover area A2 may show a relatively low peel strength since the second cover area A2 has a relatively small adhesive area and volume of pores that can accommodate the adhesive due to its relatively low surface roughness while the first cover area A1 may show a relatively high peel strength since the first cover area A1 with a relatively rough surface has a relatively large adhesive area and volume of pores that can accommodate the adhesive due to its relatively high surface roughness.

According to one or more embodiments, the cover tape T1 including the first and second cover areas A1 and A2 may have substantially the same configuration. For example, the first and second cover areas A1 and A2 may include a tape base Ta and an adhesive Tb (see FIG. 7) formed on a first surface T11 of the tape base Ta. Unlike the first cover area A1, the second cover area A2 may further include the glossy coating layer Tc formed on a second surface T12 of the tape base Ta. According to one or more embodiments, the first surface T11 of the tape base Ta may refer to an inner surface of the tape base Ta facing the battery cell 10 and the second surface T12 of the tape base Ta may refer to an outer surface of the tape base Ta facing away from the battery cell 10. In addition, according to one or more embodiments, the tape base Ta is not limited to a single layer having a homogeneous composition but may include a multi-layer laminate including a plurality of layers, each having a different homogeneous composition. For example, according to one or more embodiments, the surface of the first cover area A1 may refer to the second surface T12 of the tape base Ta and the surface of the second cover area A2 may refer to the surface of the glossy coating layer Tc formed on the second surface T12 of the tape base Ta. Accordingly, the second surface T12 of the tape base Ta, which corresponds to the surface of the first cover area A1, may be formed as a relatively rough surface and the glossy coating layer Tc formed on the second surface T12 of the tape base Ta corresponding to the surface of the second cover area A2 may be formed as a relatively smooth surface. For example, the first and second cover areas A1 and A2 may share the tape base Ta forming a common base as a component of one continuously extending cover tape T1, wherein the surface of the second cover area A2 may be formed from the glossy coating layer Tc formed on the tape base Ta while the surface of the first cover area A1 may be formed from the tape base Ta (e.g., the second surface T12 of the tape base Ta). As such, since the first and second cover areas A1 and A2 share the tape base Ta as a common base of the first and second cover area A1 and A2, the process of forming the first and second cover areas A1 and A2 with different surface characteristics may be simplified. For example, according to one or more embodiments, the cover tape T1 including the first and second cover areas A1 and A2 having different surface characteristics may be formed by selectively applying the glossy coating layer Tc to an area corresponding to the second cover area A2, excluding an area corresponding to the first cover area A1, on the second surface T12 of the tape base Ta shared as a common base by the first and second cover areas A1 and A2. As such, according to one or more embodiments, the fact that the first and second cover areas A1 and A2 have different surface characteristics may mean that the surface characteristics of the first cover area A1 exhibited by the second surface T12 of the tape base Ta forming the common base of the first and second cover areas A1 and A2 are different from the surface characteristics of the second cover area A2 exhibited by the glossy coating layer Tc formed on the second surface T12 of the tape base Ta. For example, the surface of the first cover area A1 may be formed as a rough surface, considering the adhesion between the first cover area A1 and the set tape ST (see FIG. 9B) which overlap with each other on the first main surface M1 of the battery cell 10. The glossy coating layer Tc formed on the second surface T12 of the tape base Ta forming the surface of the second cover area A2 may be formed as a smooth surface, considering the peeling between the second cover area A2 and the protective tape T2 which overlap with each other on the second main surface M2 of the battery cell 10.

According to one or more embodiments, the second surface T12 of the tape base Ta may form the surface of the first cover area A1. Accordingly, the tape base Ta may have a structure in which a primer or the like is applied to the fabric of the cover tape T1 to form the second surface T12 of the tape base Ta forming the surface of the first cover area A1 as a rough surface. In other words, the cover tape T1 including the first and second cover areas A1 and A2 may overall include the tape base Ta and the adhesive Tb (see FIG. 7) formed on the first surface T11 of the tape base Ta. The second surface T12 of the tape base Ta may be formed as a relatively rough surface by applying a primer and the like to the fabric of the cover tape T1 in consideration of adhesion to the set tape ST (see FIG. 9B).

For example, according to one or more embodiments, the fact that the first and second cover areas A1 and A2 have different surface characteristics may mean that the second surface T12 of the tape base Ta forming the surface of the first cover area A1 has different surface characteristics from the glossy coating layer Tc formed on the second surface T12 of the tape base Ta forming the surface of the second cover area A2. For example, the second surface T12 of the tape base Ta forming the common base of the first and second cover areas A1 and A2 has different surface characteristics from the glossy coating layer Tc formed on the second surface T12 of the tape base Ta. In this sense, according to one or more embodiments, the glossy coating layer Tc forming the surface of the second cover area A2 may include any composition with the surface characteristics, such as a relatively lower surface roughness, a relatively higher reflectivity, or a relatively lower peel strength (adhesion) than the second surface T12 (i.e., the second surface T12 of the tape base Ta forming the surface of the first cover area A1) of the tape base Ta forming the common base of the first and second cover areas A1 and A2. For example, the surface of the glossy coating layer Tc opposite to the battery cell 10 may include any configuration having a surface which exhibits the above-mentioned surface characteristics, such as a relatively low surface roughness, a relatively high reflectivity, or a relatively low peel strength (adhesion). According to one or more embodiments, the glossy coating layer Tc may show a relatively high reflectivity if a relatively smooth surface of the glossy coating layer Tc is observed from the outside. For example, the fact that high reflectivity similar to specular reflection is observed may mean that the surface characteristics of the glossy coating layer Tc are expressed. For example, according to one or more embodiments, if the surface characteristics of the layer (corresponding to the glossy coating layer Tc) formed on the tape base Ta forming the common base of the first and second cover areas A1 and A2 have a relatively low surface roughness, a relatively high reflectivity, or a relatively low peel strength, compared to the surface characteristics of the first cover area A1 or the second surface T12 of the tape base Ta forming the common base of the first and second cover areas A1 and A2 which forms the surface of the first cover area A1, the layer may be understood as the glossy coating layer Tc of the disclosure regardless of specific values of optical characteristics, such as gloss or reflectivity or peeling strength. In this sense, according to one or more embodiments, the glossy coating layer Tc formed on the second surface T12 of the tape base Ta forming the common base of the first and second cover areas A1 and A2 may be interpreted as a broad term encompassing any layer with improved surface characteristics for peeling rather than adhesion.

According to one or more embodiments, the second cover area A2 may include the second-1 cover area A2-1 which extends from the first main surface M1 of the battery cell 10 to the second main surface M2 and surrounds the first side surface S1, the second-2 cover area A2-2 which extends from the first main surface M1 of the battery cell 10 to the second main surface M2 and surrounds the second side surface S2, and the second-3 cover area A2-3 which extends from the first main surface M1 of the battery cell 10 to the second main surface M2 and surrounds the bottom surface B. On the second surface T12 of the tape base Ta corresponding to the second cover area A2, the cover tape T1 including all of the second-1 cover area A2-1, the second-2 cover area A2-2, and the second-3 cover area A2-3 covering the second main surface M2 may be formed in the second cover area A2 where the glossy coating layer Tc is formed or the cover tape T1 including some of the second-1 cover area A2-1, the second-2 cover area A2-2, and the second-3 cover area A2-3 covering the second main surface M2 may be formed in the second cover area A2 where the glossy coating layer Tc is formed, wherein the glossy coating layer Tc may not be formed in some areas without the second cover area A2 to expose the second surface T12 of the tape base Ta.

According to one or more embodiments, the second cover area A2 may include multiple areas, for example, three cover areas including a second-1 cover area A2-1 formed on the second main surface M2 adjacent to the first side surface S1, a second-2 cover area A2-2 formed on the second main surface M2 adjacent to the second side surface S2, and a second-3 cover area A2-3 formed on the second main surface M2 adjacent to the bottom surface B. According to one or more embodiments, the second-1 cover area A2-1, the second-2 cover area A2-2, and the second-3 cover area A2-3 may each be formed with different shapes and areas. For example, the second-1 cover area A2-1 may include the wide width portion W1 and the narrow width portion W2 which are stepped at different widths in the longitudinal direction of the first side surface S1. For example, the second-1 cover area A2-1 may include the wide width portion W1 formed adjacent to the first side surface S1 and the narrow width portion W2 formed far from the first side surface S1. As such, according to one or more embodiments, by forming the wide width portion W1 and the narrow width portion W2 that are stepped at different widths in the second-1 cover area A2-1, the peeling of the cover tape T1 that may start from the second cover area A2 may be easily performed. For example, the cover tape T1 surrounding the battery cell 10 may be peeled off for repairs of the battery cell 10, which peeling may be started from the narrow width portion W2 of the second cover area A2 to peel off the cover tape T1. By initiating the peeling of the cover tape T1 from the narrow width portion W2 of the second cover area A2 formed with a relatively narrow width in the longitudinal direction of the first side surface S1, for example, the narrow width portion W2 of the second-1 cover area A2-1 forming the second cover area A2, the cover tape T1 may be easily peeled off. The peeling of the cover tape T1 may be easily initiated from the narrow width portion W2 of the second-1 cover area A2-1, which has a relatively limited adhesive area with the battery cell 10 and the peeling of the cover tape T1 starting from the narrow width portion W2 may progress toward the wide width portion W1 adjacent to the narrow width portion W2. For example, according to one or more embodiments, the second-1 cover area A2-1 may be formed with a relatively greater area than the other cover areas that form the second cover area A2, including the second-2 cover area A2-2 and the second-3 cover area A2-3. As such, as the peeling of the cover tape T1 continues continuously along the relatively large area by setting the second-1 cover area A2-1, which occupies a relatively large area, as the peeling start position where peeling of the cover tape T1 starts, the cover tape T1 may be easily peeled off. According to one or more embodiments, as the end portion of the cover tape T1 is formed at a position relatively far from the first side surface S1, the narrow width portion W2 of the second-1 cover area A2-1, which is formed with a relatively narrow width in the longitudinal direction of the first side surface S1, may be used as the peeling start position. According to one or more embodiments, the peeling tab (not shown) for peeling off the cover tape T1 may be formed in the second-1 cover area A2-1. For example, according to one or more embodiments, the peel tab may be formed on the wide width portion W1 with a relatively wide width in the longitudinal direction of the first side surface S1 in the second-1 cover area A2-1. According to some embodiments, the second-1 cover area A2-1 may provide the peeling start position where the peeling of the cover tape T1 starts. For example, the narrow width portion W2 of the second-1 cover area A2-1 may be provided as the peeling start position of the cover tape T1. According to some embodiments, the peeling tab formed on the wide width portion W1 of the second-1 cover area A2-1 may also be provided as the peeling start position of the cover tape T1. The cover tape T1 may be peeled from the battery cell 10 by using the narrow width portion W2 and the peeling tab as different peeling start positions.

The second-2 cover area A2-2 may be formed on the second main surface M2 adjacent to the second side surface S2 and may extend in the longitudinal direction of the second side surface S2 on the second main surface M2 adjacent to the second side surface S2. The second-2 cover area A2-2 may be formed at a position opposite to the second-1 cover area A2-1 in the direction where the first and second side surfaces S1 and S2 face each other, may extend in the longitudinal direction of the second side surface S2 with substantially the same width in the longitudinal direction of the second side surface S2, and may be formed with an area smaller than the second-1 cover area A2-1.

According to one or more embodiments, the cover tape T1 may be formed with wing portions 50 (see FIG. 6) protruding from the second-1 cover area A2-1 and the second-2 cover area A2-2. To cover the bottom surface B and the side surface S1 and S2 adjacent to the second main surface M2 of the battery cell 10 covered by the second-1 cover area A2-1 and the second-2 cover area A2-2, the wing portions 50 (see FIG. 6) may protrude from the second-1 cover area A2-1 and the second-2 cover area A2-2 toward the first and second side surfaces S1 and S2 and the bottom surface B of the battery cell 10.

The second-3 cover area A2-3 may include a pair of second-3 cover areas A2-3 spaced apart from each other in the longitudinal direction of the bottom surface B at a location adjacent to the bottom surface B. As such, the cover tape T1 may be easily peeled from the pair of second-3 cover areas A2-3 which are separate from each other. For example, the cover tape T1 surrounding the battery cell 10 may be easily peeled off through the peeling from the second-1 cover area A2-1 adjacent to the first side surface S1 and the peeling from the second-3 cover area A2-3 adjacent to the bottom surface B. According to one or more embodiments, the second-3 cover area A2-3 may be formed with a smaller area than the other areas forming the second cover area A2 including the second-1 cover area A2-1 and the second-2 cover area A2-2. The second-3 cover area A2-3 may be formed with the smallest area among the second-1 cover area A2-1, the second-2 cover area A2-2, and the second-3 cover area A2-3 that form the second cover area A2. For example, the second-1 cover area A2-1 may provide the peeling start position for peeling the cover tape T1 from the battery cell 10 through the narrow width portion W2. The second-3 cover area A2-3 formed with a relatively small area as a pair of second-3 cover areas A2-3 spaced apart from each other may provide another peeling start position. The second-2 cover area A2-2 may provide, for example, a peeling end position of the cover tape T1 rather than providing the peeling start position of the cover tape T1. According to some embodiments, the peeling tab (not shown) formed on the wide width portion W1 of the second-2 cover area A2-2 may also provide the peeling start position of the cover tape T1.

For example, the peeling of the cover tape T1 starting from the second-1 cover area A2-1 and the second-3 cover area A2-3 may proceed along the first main surface M1 and may end at the second-2 cover area A2-2 on the second main surface M2. According to one or more embodiments, the second-1 cover area A2-1 may be formed with a relatively wide area to provide a stable peeling start position. The second-3 cover area A2-3 may be formed with the smallest area to easily initiate the peeling. The second-2 cover area A2-2 which provides the peeling end position may be formed with an area approximately halfway between the second-1 cover area A2-1 and the second-3 cover area A2-3. For example, the second-1 cover area A2-1 may be formed with a relatively large area to initiate the peeling of the cover tape T1 and to ensure the stable peeling, and the second-3 cover area A2-3 may provide another peeling start position for peeling the cover tape T1 from the bottom surface B so as not to interfere with the peeling of the cover tape T1 which starts from the first main surface M1. According to one or more embodiments, the protective tape T2 may be attached to the second main surface M2 of the battery cell 10 from the central position of the battery cell 10 exposed from the second-1 cover area A2-1, the second-2 cover area A2-2, or the second-3 cover area A2-3, to cover all of the second-1 cover area A2-1, second-2 cover area A2-2, and second-3 cover area A2-3 forming the second cover area A2. According to one or more embodiments, the protective tape T2 may be attached to the second main surface M2 from the central position of the second main surface M2 where the end portions are concentrated, to cover all the end portion of the second-1 cover area A2-1 or the second-3 cover area A2-3.

According to one or more embodiments, for repairs of the battery cell 10, it may be necessary to peel off the cover tape T1 and the protective tape T2 surrounding the battery cell 10. For example, to provide the peeling start position where the peeling of the protective tape T2 starts, the peeling tab T2a may be formed on one side of the protective tape T2 for providing the peeling start position. For example, the peeling tab T2a of the protective tape T2 may protrude beyond the second main surface M2 and toward the outside of the battery cell 10. According to one or more embodiments, the protective tape T1 attached to the second main surface M2 of the battery cell 10 may be peeled off and the cover tape T1 may be peeled off from the peeling tab (not shown) formed on the cover tape T1 or the end portion of the second cover area A2 exposed after peeling off the protective tape T2, as the peeling start position. The battery cell 10 may be exposed due to the peeling of the cover tape T1 and the exposed battery cell 10 may be repaired.

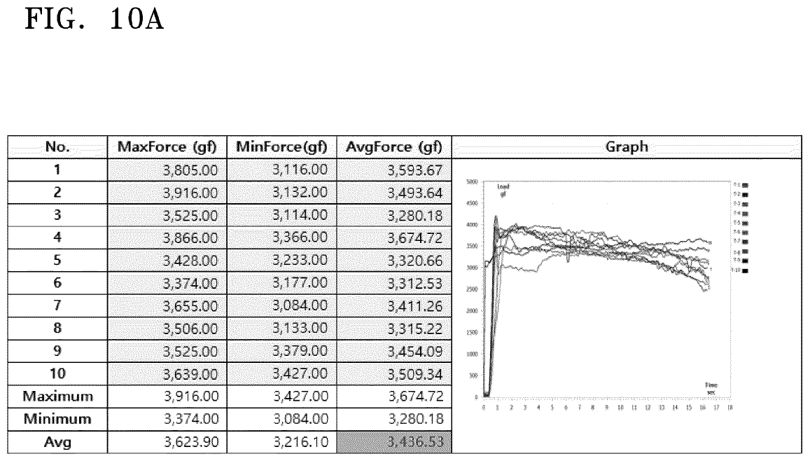

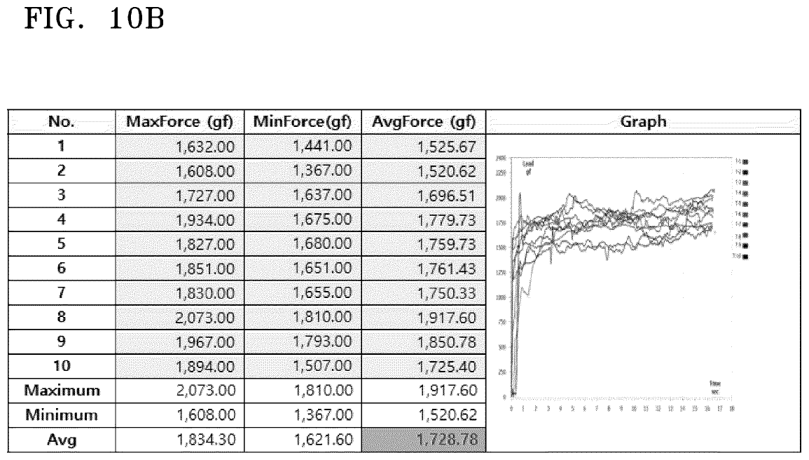

FIGS. 10A and 10B show the results of an experiment for evaluating the adhesion of the cover tape without the glossy coating layer and the adhesion of the cover tape with the glossy coating layer to confirm the difference in adhesion depending on whether or not a glossy coating layer is formed.

Referring to FIG. 10A, an average adhesive force of 3,436.53 gf was measured for the cover tape without the glossy coating layer. Referring to FIG. 10B, an average adhesive force of 1,728.78 gf was measured for the cover tape with the glossy coating layer. From these experimental results, it was confirmed that the adhesive strength decreased due to the formation of the glossy coating layer and it was confirmed that the adhesive strength decreased by approximately 50%. For example, in the experiments of FIGS. 10A and 10B, the same counterpart object including the same adhesive and the same tape base was attached to the cover tape without the glossy coating layer and the cover tape with the glossy coating layer, respectively, and the peel strength or adhesion for peeling off the counterpart object attached to each cover tape was measured.

According to the disclosure, for maintenance of a battery cell, provided is a battery pack with improved surface characteristics to achieve different adhesion or peel strength depending on the position of the cover tape, thereby eliminating failure to peel off or reattach the cover tape caused by the adhesive of the protective tape remaining on the cover tape if the cover tape surrounding the battery cell and the protective tape exposed from the cover tape including the end portion of the cover tape are peeled off.

It should be understood that embodiments described herein should be considered in a descriptive sense only and not for purposes of limitation. Descriptions of features or aspects within each embodiment should typically be considered as available for other similar features or aspects in other embodiments. While one or more embodiments have been described with reference to the figures, it will be understood by those of ordinary skill in the art that various changes in form and details may be made therein without departing from the spirit and scope of the present disclosure as defined by the following claims.

Example embodiments have been disclosed herein, and although specific terms are employed, they are used and are to be interpreted in a generic and descriptive sense only and not for purpose of limitation. In some instances, as would be apparent to one of ordinary skill in the art as of the filing of the present application, features, characteristics, and/or elements described in connection with a particular embodiment may be used singly or in combination with features, characteristics, and/or elements described in connection with other embodiments unless otherwise specifically indicated. Accordingly, it will be understood by those of skill in the art that various changes in form and details may be made without departing from the spirit and scope of the present invention as set forth in the following claims.

What is claimed is:

1. A battery pack, comprising:
a battery cell comprising a first main surface and a second main surface facing each other; and
cover tape comprising a first cover area and a second cover area being different areas on the first main surface and the second main surface of the battery cell, respectively, and an inner surface facing the battery cell and an outer surface facing away from the battery cell, wherein the cover tape comprises a glossy coating layer forming an outer surface of the second cover area.

2. The battery pack as claimed in claim 1, wherein the outer surface of the second cover area has a lower surface roughness than an outer surface of the first cover area.

3. The battery pack as claimed in claim 1, wherein the outer surface of the second cover area has a higher reflectivity than an outer surface of the first cover area.

4. The battery pack as claimed in claim 1, wherein the outer surface of the second cover area has a lower peel strength or adhesion than an outer surface of the first cover area.

5. The battery pack as claimed in claim 4, wherein, with respect to peel strength or adhesion for peeling off counterpart objects attached to the outer surface of the second cover area and the outer surface of the first cover area from the outer surface of the second cover area and the outer surface of the first cover area, respectively, the peel strength or adhesion of the outer surface of the second cover area is lower than a peel strength or adhesion of the outer surface of the first cover area.

6. The battery pack as claimed in claim 1, wherein:
the first cover area and the second cover area are continuous along a tape base, the tape base being a common support base for the first cover area and the second cover area,
an outer surface of the first cover area is formed by an outer surface of the tape base, and
the outer surface of the second cover area is formed by the glossy coating layer on the outer surface of the tape base.

7. The battery pack as claimed in claim 6, wherein, compared to the outer surface of the tape base forming the outer surface of the first cover area, an outer surface of the glossy coating layer forming the outer surface of the second cover area comprises at least one surface characteristic, the at least one surface characteristic comprising:
i) a lower surface roughness;
ii) a higher reflectivity; or
iii) a lower peel strength or adhesion.

8. The battery pack as claimed in claim 6, wherein, compared to the outer surface of the tape base of the second cover area where the glossy coating layer is formed, the outer surface of the second cover area formed by the glossy coating layer comprises at least one surface characteristic, the at least one surface characteristic comprising:
i) a lower surface roughness;
ii) a higher reflectivity; or
iii) a lower peel strength or adhesion.

9. The battery pack as claimed in claim 6, wherein the cover tape comprises:
the tape base forming a common support base for the first and second cover areas;
the glossy coating layer formed in the second cover area on the outer surface of the tape base; and
an adhesive layer formed in the first and second cover areas on an inner surface of the tape base.

10. The battery pack as claimed in claim 1, wherein the battery cell further comprises:
a top surface and a bottom surface opposite each other that connect the first main surface to the second main surface; and
a first side surface and a second side surface opposite each other in a direction intersecting a direction in which the top surface faces the bottom surface, and connect the first and second main surfaces to each other, wherein the first main surface and the second main surface occupy a greater area than any of the top surface, the bottom surface, the first side surface and the second side surface.

11. The battery pack as claimed in claim 10, wherein the second cover area comprises:
a second-1 cover area extending from the first cover area formed on the first main surface to the second main surface and surrounding the first side surface;
a second-2 cover area extending from the first cover area formed on the first main surface to the second main surface and surrounding the second side surface; and
a second-3 cover area extending from the first cover area formed on the first main surface to the second main surface and surrounding the bottom surface.

12. The battery pack as claimed in claim 11, wherein the second-1 cover area is formed on the second main surface at a location adjacent to the first side surface,
the second-2 cover area is formed on the second main surface at a location adjacent to the second side surface, and
the second-3 cover area is formed on the second main surface at a location adjacent to the bottom surface, wherein an inner area of the second main surface comprising a central area of the second main surface is exposed from the second-1 cover area.

13. The battery pack as claimed in claim 12, wherein protective tape is attached to the inner area of the second main surface exposed from the second cover area.

14. The battery pack as claimed in claim 13, wherein the protective tape covers the inner area of the second main surface exposed from the cover tape and covers end portions of the second-1 cover area, the second-2 cover area, and the second-3 cover area, which extend toward the inner area.

15. The battery pack as claimed in claim 13, wherein a peeling tab for peeling off the protective tape is formed on the protective tape.

16. The battery pack as claimed in claim 11, wherein the second-1 cover area, the second-2 cover area, and the second-3 cover area are different areas and different shapes from each other.

17. The battery pack as claimed in claim 16, wherein the second-1 cover area comprises a wide width portion and a narrow width portion which are stepped at different widths in a longitudinal direction of the first side surface,
the second-2 cover area extends with a uniform width in a longitudinal direction of the second side surface, and
the second-3 cover area comprises a pair of second-3 cover areas spaced apart from each other in a longitudinal direction of the bottom surface.

18. The battery pack as claimed in claim 17, wherein:
the wide width portion of the second-1 cover area is arranged at a location relatively close to the first side surface with a relatively wide width in a longitudinal direction of the first side surface, and
the narrow width portion of the second-2 cover area is arranged at a location relatively far from the first side surface with a relatively narrow width in the longitudinal direction of the first side surface.

19. The battery pack as claimed in claim 16, wherein, among the second-1 cover area, the second-2 cover area, and the second-3 cover area, the second-1 cover area is formed with a largest area, the second-3 cover area is formed with a smallest area, and the second-2 cover area is formed with a smaller area than the second-1 cover area and a larger area than the second-3 cover area.

20. The battery pack as claimed in claim 16, wherein the cover tape comprises an area connected to the second-1 cover area and the second-2 cover area and covering the first and second side surfaces adjacent to the second main surface of the battery cell, and an area connected to the area covering the first and second side surfaces and covering the top surface and the bottom surface adjacent to the first and second side surfaces.
